(19) United States
(12) Patent Application Publication
(10) Pub. No.: US 2008/0288706 A1
(43) Pub. Date: Nov. 20, 2008

(54) MODULAR AUTOMATION DEVICE

(75) Inventors: Axel Lohbeck, Minden (DE); Wolfgang Jantzen, Minden (DE); Gerd Dewitz, Bad Salzuflen (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/107,899

(22) Filed: Apr. 23, 2008

(30) Foreign Application Priority Data
Apr. 23, 2007 (DE) 10 2007 019 048.6

(51) Int. Cl. G06F 13/40

(52) U.S. Cl. 710/305

(57) ABSTRACT

The disclosure relates to a device, arrangement and method for communication between modular devices for measurement, closed-loop control and open-loop control, which are connected to one another via a backplane. It is proposed that two modules of the device in each case be connected to one another via a serial point-to-point connection. Modules with a coupling element are connected to a plurality of other modules.

### RELATED APPLICATION

This application claims priority under 35 U.S.C. §119 to German Patent Application No. 10 2007 019 048.6 filed in Germany on Apr. 23, 2007, the entire content of which is hereby incorporated by reference in its entirety.

### TECHNICAL FIELD

A modular automation device, arrangement and method for measurement are disclosed, including closed-loop and open-loop control.

### BACKGROUND INFORMATION

DE 42 38 957 discloses a modular device whose modules are connected to one another for communication purposes by means of a plurality of serial lateral buses, which are routed in parallel, and are in the form of CAN buses.

The progress in development of devices for measurement, closed-loop and open-loop control has led to increasing volumes of data, as a result of better monitoring and diagnostic functions in particular, the transport and transmission of which volumes of data within reasonable time periods overloads even multiple bus configurations, and at the same time leads to large amounts of material being required.

### SUMMARY

The disclosure is therefore based on the object of further developing the known modular automation device such that the requirements for a high data throughput are satisfied using little material.

A modular device for measurement is disclosed, closed-loop and open-loop control, which comprises a plurality of modules which are electrically connected to one another via a common connection means.

A modular automation device is disclosed comprising a plurality of modules which are electrically connected to one another via a common connection means, wherein the connection means has at least one active coupling element with a plurality of connections which can be connected to one another in order to connect serial point-to-point connections and each module is in each case connected to at least one coupling element via a point-to-point connection.

A modular arrangement for device automation is disclosed comprising a plurality of modules which are electrically connected to one another via a common connection means, wherein the connection means has at least one active coupling element with a plurality of connections which can be connected to one another in order to connect serial point-to-point connections and each module is in each case connected to at least one coupling element via a point-to-point connection.

A method of modular arrangement is disclosed for an automation device comprising a plurality of modules which are electrically connected to one another via a common connection means. The method comprises providing a plurality of connections of at least one active coupling element of the connection means for connection to one another and to connect serial point-to-point connections and connecting each module to at least one coupling element via a point-to-point connection.

### BRIEF DESCRIPTION OF THE DRAWINGS

Further details and advantages of the disclosure will be described in the following text with reference to exemplary embodiments. In the figures which are required for this purpose:

FIG. 1 shows an outline illustration of a modular device with a coupling element in a module, and simple coupling,

FIG. 2 shows an outline illustration of a modular device with redundant coupling.

### DETAILED DESCRIPTION

According to the disclosure, the connection means has at least one active coupling element with a plurality of connections which can be connected to one another in order to connect serial point-to-point connections. Furthermore, each module is in each case connected to at least one coupling element via a point-to-point connection. In this case, all the modules are indirectly connected to one another via the coupling element via individual point-to-point connections, for communication purposes.

According to a further feature of the disclosure, the point-to-point connection is formed by a USB (Universal Serial Bus). In this case, the protocol for the universal serial bus, which is known per se, is used for communication-carrying bus physics. This includes, in particular, differential transmission of data via a pair of conductors between in each case two modules.

Appropriate communication circuits for USB operation are commercially available. As a result of the widespread use of USB in the field of personal computers, these communication circuits are manufactured in large quantities and therefore cost comparatively little in comparison to communication circuits of other less widely used bus systems. Furthermore, the software drivers for operation of the communication circuits are available for various operating systems. This advantageously means that implementation of the communication means involves little effort.

Since version 2.0 of the USB specification, the data rate on the bus has been up to 480 MBit/s. This allows a high data throughput between the modules.

According to a further feature of the disclosure, the point-to-point connection is formed by a serial bus in accordance with the firewire specification (IEEE 1394). In this case, the protocol of the firewire bus, which is known per se, is used for the communication-carrying bus physics. This includes, in particular, differential transmission of data via a pair of conductors between in each case two modules.

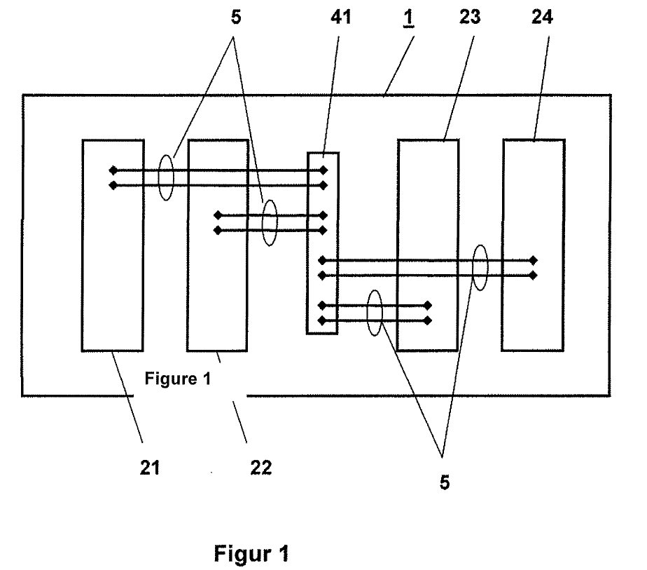

FIG. 1 shows an outline illustration of a modular device for measurement, closed-loop and open-loop control, which is accommodated in a switchgear cabinet or any other desired housing. Plug-in slots for a plurality of modules 21 to 24 of the device are arranged on a backplane printed circuit board 1. Furthermore, the backplane printed circuit board 1 is equipped with an active coupling element 41.

The coupling element 41 is connected to each of the module 21 to 24 via individual point-to-point connections 5. For this purpose, all the modules 21 to 24 of the device have at least one communication interface for connection of a point-to-point connection 5.

In this case, it is possible for one of the modules 21 to be a control module, which is connected to a plurality of input/output modules 22 to 24 via the backplane printed circuit board 1. Furthermore, it is possible for the control module to be connected to a higher-level device, which is not illustrated. The input/output modules 22 to 24 are connected to devices which are close to the process but are not illustrated, such as sensors and actuators.

The coupling element 41 has a plurality of interfaces for connection of all the point-to-point connections 5 which can be connected to one another. The coupling element 41 is designed in such a way that any two of the connected point-to-point connections 5 can in each case be connected to one another. Coupling elements 41 such as these are known per se and are commercially available. All the modules 21 to 24 of the modular device can therefore be indirectly connected to one another for communication purposes.

In a first exemplary embodiment of the disclosure, each point-to-point connection 5 is formed by a USB (Universal Serial Bus). In this case, the protocol of the universal serial bus, which is known per se, is used for communication-carrying bus physics. This includes, in particular, differential transmission of data via a pair of conductors between in each case two modules 21 to 24. Appropriate communication circuits such as a USB hub are advantageously commercially available for its operation. Because of the widespread use of USB in the field of personal computers, these communication circuits are manufactured in large quantities, and therefore cost little in comparison to communication circuits for other less widely used bus systems. Furthermore, the software drivers for operation of the communication circuits are available for various operating systems. In consequence, the effort for implementation of the communication means is advantageously low.

In another exemplary embodiment of the disclosure, each point-to-point connection 5 is formed by a serial bus in accordance with the firewire specification (IEEE 1394). In this case, the protocol of the firewire bus, which is known per se, is used for the communication-carrying bus physics.

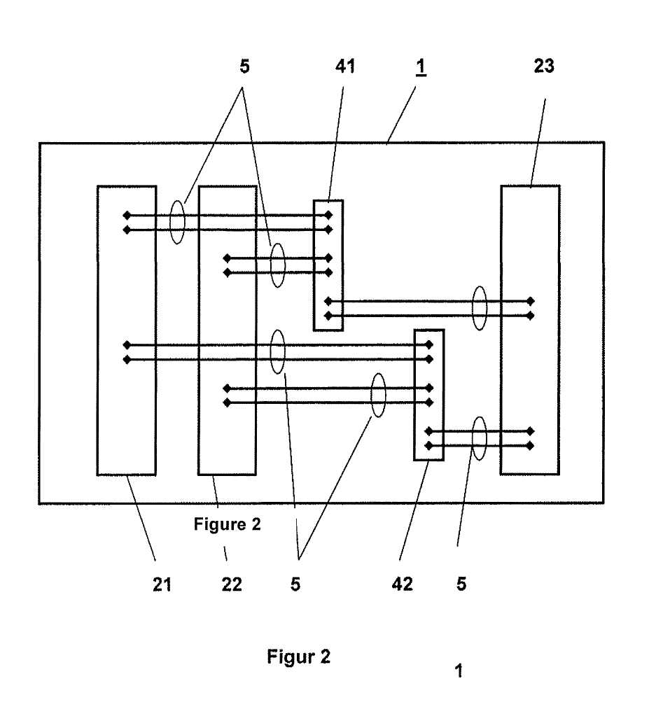

In a further refinement of the disclosure in FIG. 2, a modular device for measurement, closed-loop and open-loop control is illustrated in an outline form, using the same reference symbols for the same items, in which plug-in slots for a plurality of modules 21 to 23 of the device are arranged on a backplane printed circuit board 1. In this exemplary embodiment, the backplane printed circuit board 1 is equipped with two mutually independent, active coupling elements 41 and 42. Each module 21 to 23 is connected to each coupling element 41 and 42 by an individual point-to-point connection 5.

In one refinement of the disclosure, in which coupling elements 41 and 42 can themselves be connected separately to higher-level devices, redundant communication is provided between all the modules 21 to 23 by means of the parallel, mutually independent connection of the modules 21 to 23 by means of the two coupling elements 41 and 42.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Backplane printed circuit board
21 . . . 24 Module
41, 42 Coupling element
5 Point-to-point connection

What is claimed is:

1. A modular automation device comprising a plurality of modules which are electrically connected to one another via a common connection means, wherein
the connection means has at least one active coupling element with a plurality of connections which can be connected to one another in order to connect serial point-to-point connections and
each module is in each case connected to at least one coupling element via a point-to-point connection.

2. The device as claimed in claim 1, wherein
the point-to-point connection is formed by a USB (Universal Serial Bus).

3. The device as claimed in claim 1, wherein
the point-to-point connection is formed by a serial bus in accordance with the firewire specification (IEEE 1394).

4. A modular arrangement for device automation comprising a plurality of modules which are electrically connected to one another via a common connection means, wherein
the connection means has at least one active coupling element with a plurality of connections which can be connected to one another in order to connect serial point-to-point connections and
each module is in each case connected to at least one coupling element via a point-to-point connection.

5. The arrangement as claimed in claim 4, wherein
the point-to-point connection is formed by a universal serial bus.

6. The arrangement as claimed in claim 4, wherein
the point-to-point connection is formed by a serial bus in accordance with a firewire specification.

7. A method of modular arrangement for an automation device comprising a plurality of modules which are electrically connected to one another via a common connection means, the method comprising:
providing a plurality of connections of at least one active coupling element of the connection means for connection to one another and to connect serial point-to-point connections and
connecting each module to at least one coupling element via a point-to-point connection.

8. The method as claimed in claim 7, wherein
the point-to-point connection is formed by a universal serial bus.

9. The method as claimed in claim 7, wherein
the point-to-point connection is formed by a serial bus in accordance with a firewire specification.
